(19) United States
(12) Patent Application Publication
(10) Pub. No.: US 2026/0269521 A1
(43) Pub. Date: Sep. 10, 2026

(54) PLUG AND CONNECTOR

(71) Applicant: THK CO., LTD., Tokyo (JP)

(72) Inventor: Masashi Sugiura, Tokyo (JP)

(73) Assignee: THK CO., LTD., Tokyo (JP)

(21) Appl. No.: 19/166,533

(22) PCT Filed: Mar. 12, 2024
(86) PCT No.: PCT/JP2024/009501

§ 371 Date: Sep. 18, 2025

(30) Foreign Application Priority Data
Mar. 22, 2023 (JP) 2023-045977

(51) Int. Cl. H01R 13/627; H01R 13/6582; H01R 24/20; H01R 107/00

(52) U.S. Cl. CPC H01R 13/6275; H01R 13/6582; H01R 24/20; H01R 2107/00

(57) ABSTRACT

With a relatively simple configuration, a size or height of a connector capable of locking fitting can be reduced. A plug (20) of an aspect of this invention is a plug (20) being to be fitted to a socket (30) and including: a movable locking plate (22); and a locking claw (21) engaging with a recessed part (31) of a socket (30) and being temporarily bent in prescribed direction when fitting to the recessed part (31) is started or released. With the plug and the socket (30) fitted to each other, while the locking plate (22) is at first position, the locking claw (21) can be bent in prescribed direction; and while the locking plate (22) is at second position, a locking part (221) of the locking plate (22) gets adjacent to the locking claw (21) in prescribed direction and the locking claw (21) cannot be bent in prescribed direction.

### TECHNICAL FIELD

The present invention relates to a plug and a connector.

### BACKGROUND ART

There has been known a conventional connector capable of locking fitting by (i) a configuration that causes engagement between a crest on an outer surface of a jack and a crest on an inner surface of a plug or (ii) a configuration that includes another type of screw-fastening means. Non-Patent Literature 1 discloses a coaxial connector having the above arrangement, which causes engagement between the crests.

### CITATION LIST

### Non-Patent Literatures

### Non-Patent Literature 1

“Doujiku konekuta toha (What is coaxial connector?), [Online], To-Conne Co., Ltd., [Searched on Jan. 17, 2023], Internet <URL: https://www.to-conne.co.jp/dojiku_connector.html>

### SUMMARY OF INVENTION

### Technical Problem

However, a conventional technique such as those described above is applicable only to a configuration including a crest part having a round shape. Particularly for (i) a configuration in which a fitting part is covered with a coupling nut such that an outer periphery of the fitting part is covered therewith or (ii) a configuration in which screwing is made on a side surface of a connector, the above technique requires a large thickness, and therefore can hardly reduce the size or height. In addition, the above technique requires processing on a screw hole, which causes increase in cost and/or the like. Thus, even for the configuration that carries out locking by screwing, a tool is sometimes required.

An aspect of the present invention was made in light of the above problems, and has an object to reduce, with a relatively simple configuration, a size or a height of a connector capable of locking fitting.

### Solution to Problem

In order to attain the above object, a plug in accordance with an aspect of the present invention is a plug that is to be fitted to a socket, the plug including: a locking plate that is movable; a locking claw configured to engage with a recessed part of the socket, the locking claw being temporarily bent in a prescribed direction at a time that fitting between the locking claw and the recessed part is started or released, in a state where the plug and the socket are fitted to each other, (i) while the locking plate is at a first position, the locking claw being allowed to be bent in the prescribed direction, and (ii) while the locking plate is at a second position, a locking part of the locking plate being located at a position adjacent to the locking claw in the prescribed direction and accordingly the locking claw being not allowed to be bent in the prescribed direction.

A connector in accordance with another aspect of the present invention is a connector including: a socket and a plug that are to be fitted to each other, the plug including a locking claw configured to engage with a recessed part of the socket, the locking claw being temporarily bent in a prescribed direction at a time that fitting between the locking claw and the recessed part is started or released, one of the plug and the socket including a locking plate that is movable, in a state where the plug and the socket are fitted to each other, (i) while the locking plate is at a first position, the locking claw being allowed to be bent in the prescribed direction, and (ii) while the locking plate is at a second position, a locking part of the locking plate being located at a position adjacent to the locking claw in the prescribed direction and accordingly the locking claw being not allowed to be bent in the prescribed direction.

### Advantageous Effects of Invention

In accordance with an aspect of the present invention, it is possible to reduce, with a relatively simple configuration, a size or a height of a connector capable of locking fitting.

### BRIEF DESCRIPTION OF DRAWINGS

FIG. 1 shows, as an example, an outer appearance drawing of an outer appearance of a connector.

FIG. 2 shows, as an example, an outer appearance drawing of the connector.

FIG. 3 shows, as an example, an outer appearance drawing of the connector.

FIG. 4 shows, as examples, (i) an outer appearance drawing and cross-sectional drawings of the connector observed while a locking plate is at a first position and (ii) an outer appearance drawing and cross-sectional drawings of the connector observed while the locking plate is at a second position.

FIG. 5 shows, as an example, a cross-sectional drawing of the connector.

FIG. 6 shows, as examples, (i) outer appearance drawings of a locking plate and a plug and (ii) a cross-sectional drawing of the plug.

### DESCRIPTION OF EMBODIMENTS

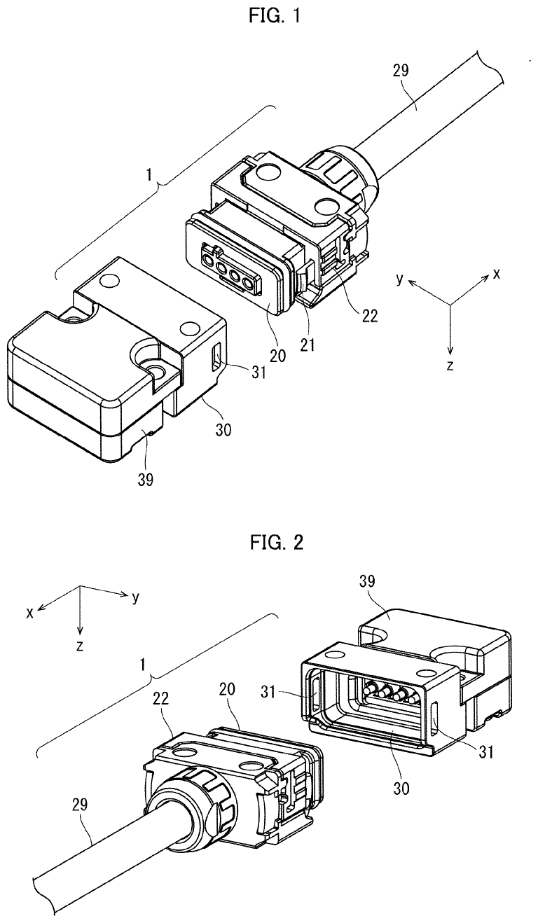

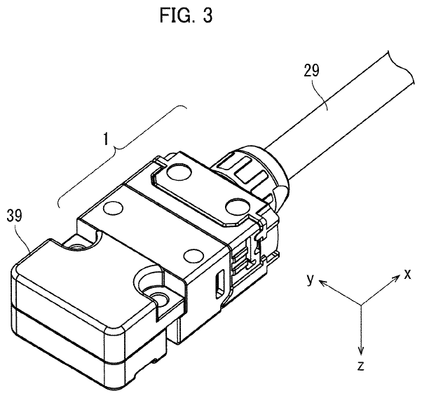

The following will describe details of an embodiment of the present invention. Each of FIGS. 1 to 3 shows, as an example, an outer appearance drawing of a connector 1 in accordance with the present embodiment. As shown in these drawings, the connector 1 includes a plug 20 and a socket 30. As viewed from another aspect, in the present embodiment, a combination of the plug 20 and the socket 30 will be referred to as the connector 1. Note that, in a case where the plug 20 and the socket 30 are not particularly distinguished from each other, one of the plug 20 and the socket 30 may be called the connector 1 in some cases.

By inserting the plug 20 into the socket 30, the plug 20 and the socket 30 are fitted to each other, and terminals for signal transmission are connected to each other. That is, the socket 30 is a member which covers an outer surface of the plug 20 when the plug 20 and the socket 30 are fitted to each other. In an example of the connector 1, the socket 30 is integrated with a sensor 39. The sensor 39 is a sensor that is attached to a guide block (a truck or a moving body), a guide rail, or the like of, e.g., a linear motion guide device (not illustrated) and that measures vibrations generated while the guide block is sliding. It is not essential that the socket 30 and the sensor 39 are integrated together. Further, the subject to be measured by the sensor 39 is not limited to the vibrations. Moreover, the sensor 39 part may include a magnet and/or an attachment that allows the sensor 39 to be attached to the guide block or the like.

The plug 20 is a member that is to be inserted into the socket 30 and that includes locking claws 21 and a locking plate 22. In addition, in the example of the connector 1, the plug 20 is connected with a cable 29 that is used to supply a measurement result of the sensor 39 to an external device.

In a state where the plug 20 and the socket 30 are fitted to each other, the locking claws 21 respectively engage with recessed parts 31 of the socket 30. Here, each of the recessed parts 31 is a hole, a groove, or a hollow into which a protruding part 211, which is a projection of a respective one of the locking claws 21, can be fitted. In many cases, the protruding parts 211 are respectively provided to tips of the locking claws 21. Further, each of the locking claws 21 is temporarily bent in a prescribed direction at a time that fitting between the locking claw 21 and a respective one of the recessed parts 31 of the socket 30 is started or released.

The locking plate 22 is a member that is movable and that can be moved to a first position or a second position by manual operation carried out by a user. In a state where the plug 20 and the socket 30 are fitted to each other, while the locking plate 22 is at the first position, the locking claws 21 are allowed to be bent in the prescribed direction. Meanwhile, in a state where the plug 20 and the socket 30 are fitted to each other, while the locking plate 22 is at the second position, locking parts 221 of the locking plate 22 are respectively located at positions adjacent to the locking claws 21 in the prescribed direction and accordingly the locking claws 21 are not allowed to be bent in the prescribed direction. That is, in a case where the plug 20 and the socket 30 are fitted to each other, the locking plate 22 can lock the locking claws 21. In order to pull the plug 20 out of the socket 30, it is necessary to release the locking.

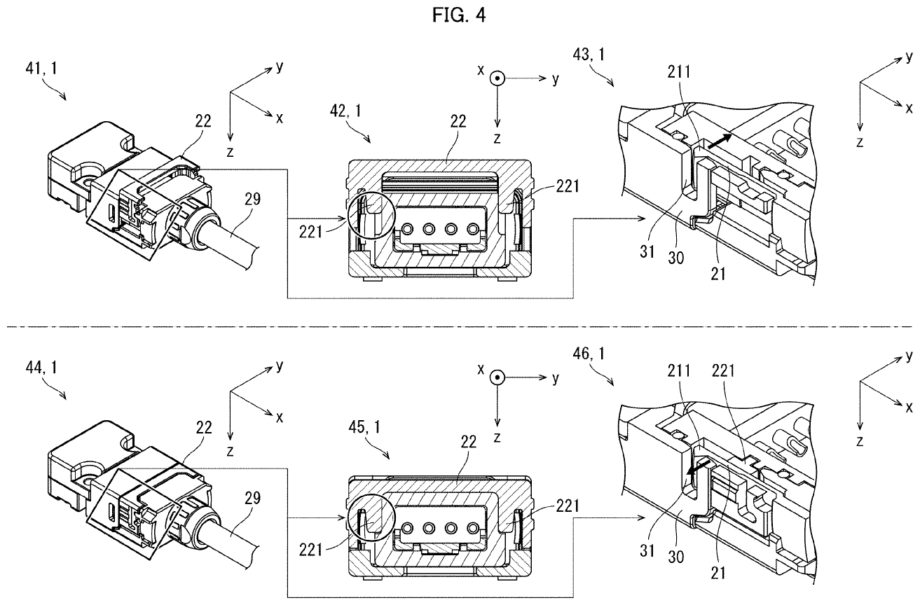

FIG. 4 shows, as examples, (i) an outer appearance drawing and cross-sectional drawings of the connector 1 observed while the locking plate 22 is at the first position and (ii) an outer appearance drawing and cross-sectional drawings of the connector 1 observed while the locking plate 22 is at the second position. A drawing in an upper part of FIG. 4, that is, an outer appearance drawing 41 and cross-sectional drawings 42 and 43 illustrate a state where the locking plate 22 is at the first position. Meanwhile, a drawing in a lower part of FIG. 4, that is, an outer appearance drawing 44 and cross-sectional drawings 45 and 46 illustrate a state where the locking plate 22 is at the second position. As shown in the outer appearance drawings 41 and 44 of FIG. 4, the locking plate 22 is movable in a z-axis direction.

As shown in the cross-sectional drawing 43, one locking claw 21 has a space located inward (in a y-axis positive direction) of the one locking claw 21; thus, the one locking claw 21 can be bent inwardly. Further, the other locking claw 21 on the opposite side (not illustrated in the cross-sectional drawing 43) can also be bent inwardly (in a y-axis negative direction).

Each of the locking claws 21 has, at its tip, the protruding part 211 having a substantially triangle shape, as viewed from the top (in a z-axis negative direction). With this, while the plug 20 is being inserted into the socket 30 or while the plug 20 is being pulled out of the socket 30, an inward force is applied to each of the locking claws 21 from a wall surface of the socket 30, as indicated by the arrow in the cross-sectional drawing 43. Thus, the locking claws 21 are temporarily bent inwardly, even without the user pressing the locking claws 21.

As illustrated in the cross-sectional drawings 42 and 43, while the locking plate 22 is at the first position, the locking parts 221, each of which is a part of the locking plate 22, do not overlap the locking claws 21, as viewed from a side surface (in a y-axis negative direction). Meanwhile, as illustrated in the cross-sectional drawings 45 and 46, while the locking plate 22 is at the second position, the locking parts 221 overlap the locking claws 21, as viewed from the side surface. That is, while the locking plate 22 is at the second position, each of the locking parts 221 is located at a position which is inwardly adjacent to a respective one of the locking claws 21 and into which the respective one of the locking claws 21 can be originally bent, and accordingly functions as a wedge. This prevents the respective one of the locking claws 21 from being bent inwardly.

While the locking plate 22 is located at the second position, the locking claws 21 cannot be bent inwardly, and accordingly the protruding parts 211 are hooked by the recessed parts 31. This prevents the plug 20 from being pulled out of the socket 30. This means that, in a state where the plug 20 and the socket 30 are fitted to each other, it is possible to lock the fitting by moving the locking plate 22 to the second position. Further, it is possible to move the locking plate 22 merely by manual operation, and it is not necessary to use any tool.

Thus, with a relatively simple configuration that utilizes only one side of the plug 20 and the thin locking claws 21, it is possible to reduce the size and the height of the connector 1 capable of locking fitting. By reducing the size and the height of the connector 1, it is possible to prevent, in a process of, e.g., attaching the sensor 39 to the guide block of the above-described motion guide device, interference of the connector 1 with a tool and/or the like in the motion guide device.

In addition, each of the locking parts 221 is configured such that (i) a part of the locking part 221 which part is closer to a base of the locking part 221 is slightly larger in a width in the prescribed direction, that is, a width in the y-axis direction than (ii) a part of the locking part 221 which part is closer to a tip of the locking part 221. Thus, as a result of movement of the locking plate 22 to the second position, the locking parts 221 act to press the locking claws 21 onto the wall surface of the socket 30, as indicated by the arrow in the cross-sectional drawing 46. This enables more reliable fitting and more reliable conduction of a shielding effect (described later).

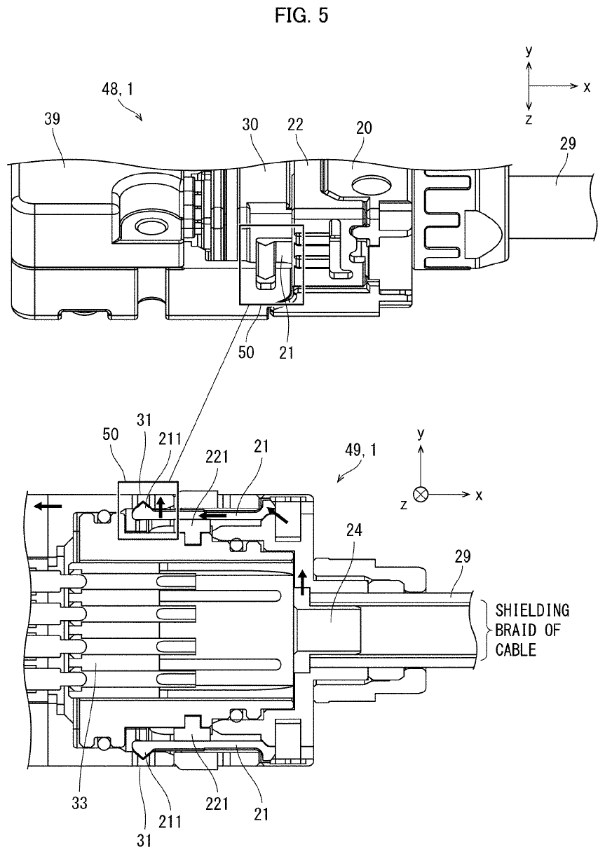

Next, the following will give, with reference to FIG. 5, supplemental information about an example of a configuration of the connector 1. FIG. 5 shows, as an example, a cross-sectional drawing of the connector 1, and illustrates a state where the plug 20 and the socket 30 are fitted to each other. As shown in the cross-sectional drawing 49, the socket 30 includes an insulator 33 that is made of a resin and that is used for insulating the terminals from each other, and the plug 20 includes a holder 24 that is made of a metal and that is used for connection with the cable 29. The cable 29 has shielding braid.

At least (i) inner surfaces of cases of the plug 20 and the socket 30 and (ii) the locking claws 21 are made of a conductor such as a metal, and the shielding effect of the cable 29 is conducted to the socket 30 via the locking claws 21. The arrows in the cross-sectional drawing 49 indicate a flow of conduction of the shielding effect. Particularly, a frame 50 indicates conduction of the shielding effect from the plug 20 to the socket 30.

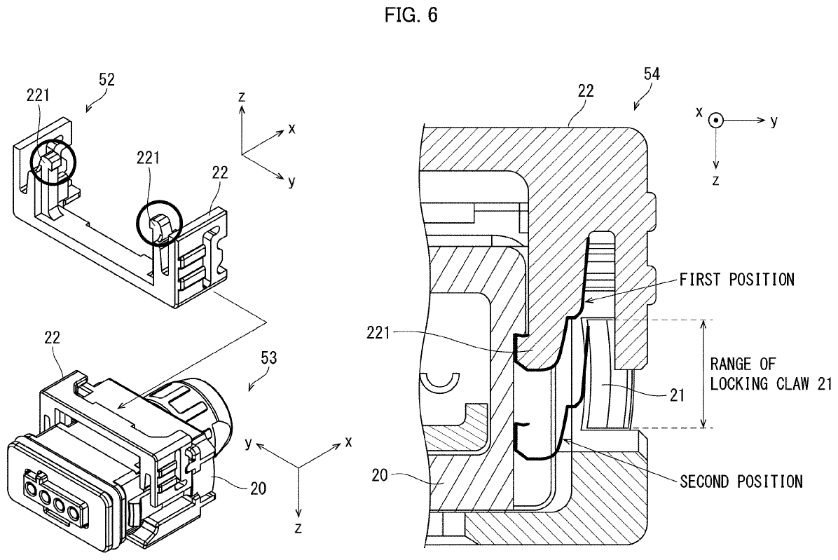

Next, the following will describe, with reference to FIG. 6, a variation of the shape of the connector 1. FIG. 6 shows, as examples, (i) outer appearance drawings of a locking plate 22 and a plug 20 and (ii) a cross-sectional drawing of the plug 20.

An outer appearance drawing 52 illustrates a state where the locking plate 22 shown in an outer appearance drawing 53 is turned upside down. As shown in the outer appearance drawing 52, the locking plate 22 has stoppers each of which is provided at a tip of a respective one of the locking parts 221 and each of which has a hook shape whose tip points inward. When the stoppers of the locking parts 221 engage with an outer surface of the case of the plug 20 (i.e., when the stoppers of the locking parts 221 engage with parts of the plug 20 in a broad sense) as shown in a cross-sectional drawing 54, the locking plate 22 cannot move to a position upward (z-axis negative direction) of the first position. This restricts a movable range of the locking plate 22, thereby preventing the locking plate 22 from falling off from the main body of the plug 20.

The plug 20 illustrated in FIG. 4 is configured such that, while the locking plate 22 is at the first position, the locking parts 221 do not overlap the locking claws 21 as viewed from the side surfaces. However, this is not limitative. Alternatively, as shown in the cross-sectional drawing 54, each of the locking parts 221 may be shaped such that an outer side of the tip of the locking part 221 is cut off to such a degree that allows a respective one of the locking claws 21 to be bent inwardly.

### Supplemental Information

The configuration that (i) the inner surfaces of the cases of the plug 20 and the socket 30 and (ii) the locking claws 21 are made of a conductor and the configuration that the cable 29 has shielding braid are not essential. For example, the connector 1 may be made of a resin.

The above description has dealt with the configuration that the prescribed direction in which the locking claws 21 are bent is the direction extending to the inner side of the locking plate 22. However, the direction in which the locking claws 21 are bent is not limited to this. Alternatively, for example, the locking claws 21 may be bent outwardly. In such a configuration, while the locking plate 22 is at the second position, each of the locking parts 221 is located at a position outwardly adjacent to a respective one of the locking claws 21.

The above description has been given, assuming that, of connectors 1 fitted to each other, one connector 1 covering an outer surface of the other connector 1 is the socket 30. However, this is not limitative. Simply, one connector 1 provided with a locking claw 21 may be regarded as a plug 20. That is, the connector 1 may be configured to include a plug 20 that is provided with a locking claw 21 and that covers an outer surface of a socket 30. A plug 20 may be provided with a sensor 39, and a socket 30 may be connected with a cable 29.

From the viewpoint of reducing the size and height, it is desirable that each of the plug 20 and the socket 30 have a cross section (yz plane) having a horizontally-longer substantially rectangular shape, as shown in FIG. 1 and the like. That is, four sides of a cross section of the plug 20 which cross section is perpendicular to the direction in which the plug 20 is inserted into the socket 30 include (i) a first side that is provided with the locking claw 21 and (ii) another side that is adjacent to the first side and that is not provided with the locking claw 21, and the another side is desirably longer than the first side. Note that each of the plug 20 and the socket 30 may alternatively have a cross section having a vertically-longer rectangular shape. The shape of the cross section is not limited to a rectangular shape. The present disclosure also encompasses a configuration that the shape of the cross section is a hexagonal shape or a circular shape.

The number of locking claws 21 provided to the plug 20 is not limited to two, and may alternatively be one or three or more. The present disclosure also encompasses a configuration that a plug 20 is provided with a plurality of locking claws 21 and a locking plate 22 locks only a part of the plurality of locking claws 21.

The locking plate 22 may not be provided to the plug 20, but may alternatively be provided to the socket 30.

Furthermore, in addition to the plug 20, the socket 30 may also be connected with a cable. From another point of view, the configuration of the connector 1 is also applicable to a configuration that connects the cables to each other.

Aspects of the present invention can also be expressed as follows:

A plug (20) in accordance with a first aspect of the present invention is a plug that is to be fitted to a socket (30), the plug including: a locking plate (22) that is movable; a locking claw (21) configured to engage with a recessed part (31) of the socket, the locking claw being temporarily bent in a prescribed direction at a time that fitting between the locking claw and the recessed part is started or released, in a state where the plug and the socket are fitted to each other, (i) while the locking plate is at a first position, the locking claw being allowed to be bent in the prescribed direction, and (ii) while the locking plate is at a second position, a locking part (221) of the locking plate being located at a position adjacent to the locking claw in the prescribed direction and accordingly the locking claw being not allowed to be bent in the prescribed direction.

A plug in accordance with a second aspect of the present invention may be configured such that, in the first aspect, the plug is connected with a cable (29) having shielding braid; and the locking claw is made of a conductor, and conducts a shielding effect of the cable to the socket.

A plug in accordance with a third aspect of the present invention may be configured such that, in the first or second aspect, (i) a part of the locking part which part is closer to a base of the locking part is larger in a width in the prescribed direction than (ii) a part of the locking part which part is closer to a tip of the locking part; and while the locking plate is at the second position, the locking part acts to press the locking claw onto a wall surface of the socket.

A plug in accordance with a fourth aspect of the present invention may be configured such that, in any one of the first to third aspects, the locking part has a stopper at a tip of the locking part, the stopper having a hook shape; and while the locking plate is at the first position, in a case where the tip of the locking part engages with a part of the plug, a movable range of the locking plate is restricted.

A plug in accordance with a fifth aspect of the present invention may be configured such that, in any one of the first to fourth aspects, the plug has a cross section that is perpendicular to a direction in which the plug is inserted into the socket and that has a substantially rectangular shape; and four sides of the cross section include a first side that is provided with the locking claw and a second side that is adjacent to the first side and that is not provided with the locking claw, the second side being longer than the first side.

A connector (1) in accordance with a sixth aspect of the present invention is a connector including: a socket (30) and a plug (20) that are to be fitted to each other, the plug including a locking claw (21) configured to engage with a recessed part (31) of the socket, the locking claw being temporarily bent in a prescribed direction at a time that fitting between the locking claw and the recessed part is started or released, one of the plug and the socket including a locking plate (22) that is movable, in a state where the plug and the socket are fitted to each other, (i) while the locking plate is at a first position, the locking claw being allowed to be bent in the prescribed direction, and (ii) while the locking plate is at a second position, a locking part (221) of the locking plate being located at a position adjacent to the locking claw in the prescribed direction and accordingly the locking claw being not allowed to be bent in the prescribed direction.

### REFERENCE SIGNS LIST

1: connector
20: plug
21: locking claw
22: locking plate
29: cable
30: socket
31: recessed part
39: sensor
211: protruding part
221: locking part

1. A plug that is to be fitted to a socket, the plug comprising:
a locking plate that is movable;
a locking claw configured to engage with a recessed part of the socket, the locking claw being temporarily bent in a prescribed direction at a time that fitting between the locking claw and the recessed part is started or released,
in a state where the plug and the socket are fitted to each other, (i) while the locking plate is at a first position, the locking claw being allowed to be bent in the prescribed direction, and (ii) while the locking plate is at a second position, a locking part of the locking plate being located at a position adjacent to the locking claw in the prescribed direction and accordingly the locking claw being not allowed to be bent in the prescribed direction.

2. The plug according to claim 1, wherein:
the plug is connected with a cable having shielding braid; and
the locking claw is made of a conductor, and conducts a shielding effect of the cable to the socket.

3. The plug according to claim 1, wherein:
(i) a part of the locking part which part is closer to a base of the locking part is larger in a width in the prescribed direction than (ii) a part of the locking part which part is closer to a tip of the locking part; and
while the locking plate is at the second position, the locking part acts to press the locking claw onto a wall surface of the socket.

4. The plug according to claim 1, wherein:
the locking part has a stopper at a tip of the locking part, the stopper having a hook shape; and
while the locking plate is at the first position, in a case where the tip of the locking part engages with a part of the plug, a movable range of the locking plate is restricted.

5. The plug according to claim 1, wherein:
the plug has a cross section that is perpendicular to a direction in which the plug is inserted into the socket and that has a substantially rectangular shape; and
four sides of the cross section include a first side that is provided with the locking claw and a second side that is adjacent to the first side and that is not provided with the locking claw, the second side being longer than the first side.

6. A connector comprising:
a socket and a plug that are to be fitted to each other,
the plug including a locking claw configured to engage with a recessed part of the socket, the locking claw being temporarily bent in a prescribed direction at a time that fitting between the locking claw and the recessed part is started or released,
one of the plug and the socket including a locking plate that is movable, in a state where the plug and the socket are fitted to each other, (i) while the locking plate is at a first position, the locking claw being allowed to be bent in the prescribed direction, and (ii) while the locking plate is at a second position, a locking part of the locking plate being located at a position adjacent to the locking claw in the prescribed direction and accordingly the locking claw being not allowed to be bent in the prescribed direction.
